(19) United States
(12) Patent Application Publication
(10) Pub. No.: US 2026/0229014 A1
(43) Pub. Date: Aug. 6, 2026

(54) SYSTEMS AND METHODS FOR CLASSIFYING BRANCHED ANATOMICAL STRUCTURES

(71) Applicant: Intuitive Surgical Operations, Inc., Sunnyvale, CA (US)

(72) Inventors: Jose Bouza, Braselton, GA (US); Junning Li, San Jose, CA (US); Dmitry Isaev, Durham, NC (US)

(21) Appl. No.: 19/151,077

(22) PCT Filed: Feb. 26, 2024
(86) PCT No.: PCT/US2024/017310

§ 371 Date: Jul. 25, 2025

Related U.S. Application Data
(60) Provisional application No. 63/448,955, filed on Feb. 28, 2023.

(51) Int. Cl. G06V 10/764; G06V 10/86; G06V 10/94

(52) U.S. Cl. CPC G06V 10/764; G06V 10/86; G06V 10/945; G06V 2201/03

(57) ABSTRACT

An example method may include generating, by a computing device, a graph based on segmentation data representing a branched anatomical structure, the graph representing a plurality of possible paths to a branch of the branched anatomical structure, the plurality of possible paths comprising a plurality of additional branches. The method may further include applying, by the computing device, a graph analysis algorithm to the graph, wherein the applying the graph analysis algorithm includes generating, for a possible path of the plurality of possible paths to the branch, a path probability value based on link affinity values of pairs of the additional branches on the possible path to the branch. The method may further include classifying, by the computing device and based on the applying the graph analysis algorithm, a branch of the branched anatomical structure.

### RELATED APPLICATIONS

This application claims priority to U.S. Provisional Patent Application No. 63/448,955, filed Feb. 28, 2023, the contents of which is hereby incorporated by reference in its entirety.

### BACKGROUND INFORMATION

Medical procedures may include procedures on various organs and tissues of a patient (or any other subject). Certain organs and tissues may include branched anatomical structures (e.g., blood vessels, airways, nerves, etc.). Determining classifications of such branched anatomical structures may be useful. However, determining such classifications may be nontrivial.

### SUMMARY

The following description presents a simplified summary of one or more aspects of the systems and methods described herein. This summary is not an extensive overview of all contemplated aspects and is intended to neither identify key or critical elements of all aspects nor delineate the scope of any or all aspects. Its sole purpose is to present one or more aspects of the systems and methods described herein as a prelude to the detailed description that is presented below.

An example method includes generating, by a computing device, a graph based on segmentation data representing a branched anatomical structure, the graph representing a plurality of possible paths to a branch of the branched anatomical structure, the plurality of possible paths comprising a plurality of additional branches; applying, by the computing device, a graph analysis algorithm to the graph, wherein the applying the graph analysis algorithm comprises generating, for a possible path of the plurality of possible paths to the branch, a path probability value based on link affinity values of pairs of the additional branches on the possible path to the branch; and classifying, by the computing device and based on the applying the graph analysis algorithm, a branch of the branched anatomical structure.

An example system includes a memory storing instructions and a processor communicatively coupled to the memory and configured to execute the instructions to generate a graph based on segmentation data representing a branched anatomical structure, the graph representing a plurality of possible paths to a branch of the branched anatomical structure, the plurality of possible paths comprising a plurality of additional branches; apply a graph analysis algorithm to the graph, wherein the applying the graph analysis algorithm comprises generating, for a possible path of the plurality of possible paths to the branch, a path probability value based on link affinity values of pairs of the additional branches on the possible path to the branch; classify, based on the applying the graph analysis algorithm, a branch of the branched anatomical structure; and generate, based on the classifying, an output indicating a classification of the branch.

An example non-transitory computer-readable medium storing instructions executable by a processor to generate a graph based on segmentation data representing a branched anatomical structure, the graph representing a plurality of possible paths to a branch of the branched anatomical structure, the plurality of possible paths comprising a plurality of additional branches; apply a graph analysis algorithm to the graph, wherein the applying the graph analysis algorithm comprises generating, for a possible path of the plurality of possible paths to the branch, a path probability value based on link affinity values of pairs of the additional branches on the possible path to the branch; classify, based on the applying the graph analysis algorithm, a branch of the branched anatomical structure; and generate, based on the classifying, an output indicating a classification of the branch.

### BRIEF DESCRIPTION OF THE DRAWINGS

The accompanying drawings illustrate various embodiments and are a part of the specification. The illustrated embodiments are merely examples and do not limit the scope of the disclosure. Throughout the drawings, identical or similar reference numbers designate identical or similar elements.

FIG. 1 depicts an illustrative branched anatomical classification system according to principles described herein.

FIGS. 2-3 depict illustrative configurations including branched anatomical classification systems according to principles described herein.

FIGS. 4-5 depict illustrative branched anatomical models according to principles described herein.

FIGS. 6A-9 depict illustrative branched anatomical classifications according to principles described herein.

FIG. 10 depicts an illustrative computer-assisted robotic medical system according to principles described herein.

FIGS. 11-12 depict illustrative methods of classifying branched anatomical structures according to principles described herein.

FIG. 13 depicts an illustrative computing device according to principles described herein.

### DETAILED DESCRIPTION

Systems and methods for branched anatomical structure classification are described herein. An example method may include generating, by a computing device, a graph based on segmentation data representing a branched anatomical structure, the graph representing a plurality of possible paths to a branch of the branched anatomical structure, the plurality of possible paths comprising a plurality of additional branches. The method may further include applying, by the computing device, a graph analysis algorithm to the graph, wherein the applying the graph analysis algorithm comprises generating, for a possible path of the plurality of possible paths to the branch, a path probability value based on link affinity values of pairs of the additional branches on the possible path to the branch. The method may further include classifying, by the computing device and based on the applying the graph analysis algorithm, a branch of the branched anatomical structure.

There may be a number of branched anatomical structures within a subject, such as blood vessels, airway bronchi, nerve structures, etc. Classifying each branch (e.g., labeling a branch as associated to a particular path) may be useful in various medical procedures. For example, it may be useful to know whether a blood vessel is an artery or a vein. As another example, knowing a bronchial path to reach a particular bronchial tube branch may be helpful. However, labeling each branch of a branched anatomical structure may be resource consuming. Automatically determining such classifications may be advantageous, but as branches get smaller and/or overlap, such determinations may be nontrivial.

Systems and methods described herein may be configured to classify branches of a branched anatomical system by generating a graph representation of the branched anatomical system and using graph analysis algorithms on the generated graph. Further, the system may output data representative of the classifications and provide user interfaces for interacting with the output data.

Systems and methods described herein may provide various advantages and benefits. As described herein, for example, algorithms used by the system may result in classification of branches that more accurately reflect actual classifications than conventional systems. Such accurate classification of branches may allow for better optimized and more efficient medical procedures that improve subject outcomes compared to conventional systems and methods.

Various illustrative embodiments will now be described in more detail. The disclosed systems and methods may provide one or more of the benefits mentioned above and/or various additional and/or alternative benefits that will be made apparent herein.

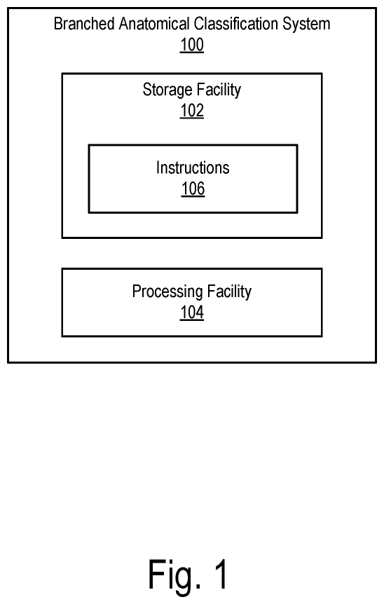

FIG. 1 illustrates an example branched anatomical classification system 100 (“system 100”) configured to perform various operations described herein. As shown, system 100 may include, without limitation, a storage facility 102 and a processing facility 104 selectively and communicatively coupled to one another. Facilities 102 and 104 may each include or be implemented by hardware (e.g., processors, memories, communication interfaces, etc.) and/or software components (e.g., instructions stored in memory for execution by the processors). For example, facilities 102 and/or 104 may be implemented by any component in a computer-assisted medical system configured to perform a medical procedure. As another example, facilities 102 and/or 104 may be implemented by a computing device separate from and communicatively coupled to a computer-assisted medical system. Although facilities 102 and 104 are shown to be separate facilities in FIG. 1, facilities 102 and 104 may be combined into fewer facilities, such as into a single facility, or divided into more facilities as may serve a particular implementation. In some examples, each of facilities 102 and 104 may be distributed between multiple devices and/or multiple locations as may serve a particular implementation.

Storage facility 102 may maintain (e.g., store) executable data used by processing facility 104 to perform one or more of the operations described herein. For example, storage facility 102 may store instructions 106 that may be executed by processing facility 104 to perform one or more of the operations described herein. Instructions 106 may be implemented by any suitable application, software, code, and/or other executable data instance. Storage facility 102 may also maintain any data received, generated, managed, used, and/or transmitted by processing facility 104.

Processing facility 104 may be configured to perform (e.g., execute instructions 106 stored in storage facility 102 to perform) various operations described herein. For example, processing facility 104 may be configured to generate a graph based on segmentation data representing a branched anatomical structure and classify, based on applying a graph analysis algorithm to the graph, one or more branches of the branched anatomical structure. These and other operations that may be performed by system 100 (e.g., processing facility 104) are described herein.

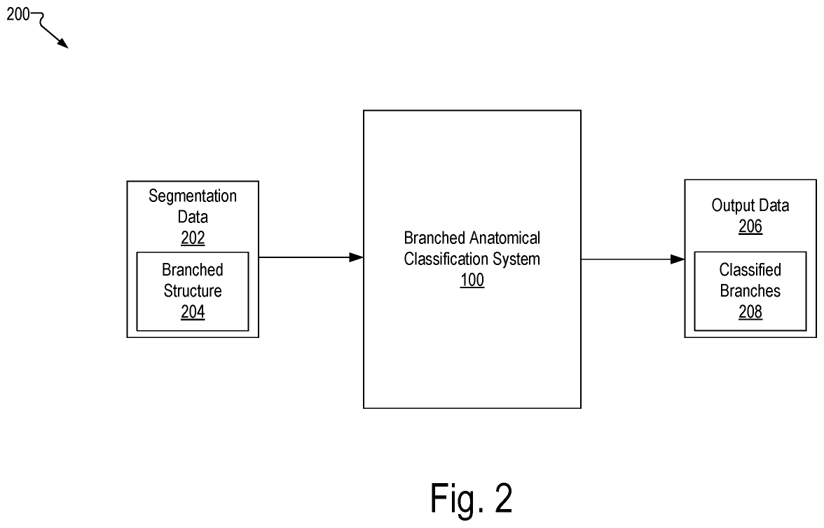

FIG. 2 illustrates an example configuration 200 of branched anatomical classification system 100. Configuration 200 shows system 100 accessing (e.g., receiving, retrieving, generating, etc.) segmentation data 202. Segmentation data 202 may include any data representative of any suitable representation of a segmentation instance of any branched anatomical structure (e.g., branched structure 204) found in an anatomy of a subject. For example, branched structure 204 may include a blood vessel structure, a bronchial airway structure, a nerve structure, or any other branching anatomical structure of a subject. The segmentation instance may include any modeled representation of branched structure 204, such as a visual representation including two-dimensional imagery, three-dimensional imagery, four-dimensional imagery (three-dimensional imagery with a time component), color imagery, depth data, texture data, etc.

While segmentation data 202 may identify branched structure 204 from surrounding tissue and/or anatomical space, segmentation data 202 may, in some examples, not include a classification of some or all branches of branched structure 204. For example, for a blood vessel structure, segmentation data 202 may lack classification of the blood vessels as arteries or veins for some or all of the blood vessels. As another example, for an airway structure, segmentation data 202 may lack a classification of bronchial paths for some portions of the airway branches.

Classification of branches may be useful for various applications, such as for a medical procedure. However, classification of the branches may be nontrivial for at least some of the branches in branched structure 204. For instance, there may be portions of segmentation data 202 where branches overlap and/or run close together. Thus, two branches may seem to converge at a branching point in the segmentation instance, though anatomically the branches remain distinct. It may be nontrivial to determine a correct classification of the branches as the branches then extend from the branching point in the segmentation instance.

System 100 may be configured to receive segmentation data 202 and determine a classification for one or more branches of branched structure 204. For instance, system 100 may be configured to generate a graph based on segmentation data 202 and apply a graph analysis algorithm to the graph. System 100 may be further configured to classify, based on the analyzed graph, one or more branches of branched structure 204. System 100 may provide output data 206 that includes classified branches 208 of branched structure 204. For example, output data 206 may include segmentation data 202 with additional information to indicate classified branches 208 such as one or more branch masks (e.g., an artery mask, a vein mask, bronchial path masks, etc.). For instance, for a blood vessel structure, system 100 may classify the vessels as arteries or veins and output data 206 may show the blood vessels in different colors (e.g., red for arteries and blue for veins). Additional examples of output data 206 are described herein.

Output data 206 may be used in various ways. For example, output data 206 may be utilized for optimizing parameters for a medical procedure and/or a medical session. A medical procedure may include any activity conducted on a patient, such as minimally-invasive surgical procedures, open surgical procedures, non-surgical procedures, diagnostic procedures, therapeutic procedures, procedures in clinical, non-clinical, and/or training settings, etc. A medical session may include any activities associated with preparing for, performing, and finalizing the medical procedure, such as pre-procedure activities, intra-procedure activities, and/or post-procedure activities. Additionally or alternatively, output of system 100 may be applied for activities associated with a medical session, such as planning the medical procedure, evaluating the medical procedure, etc.

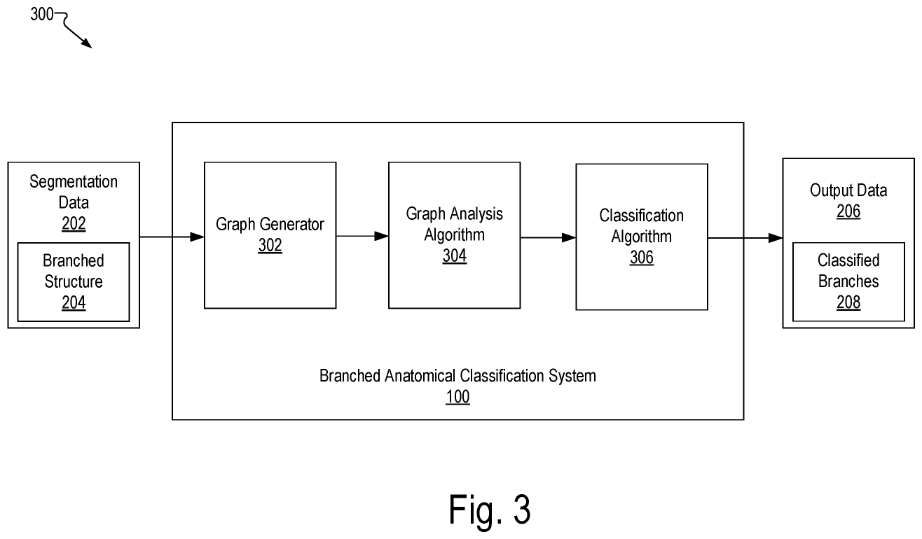

FIG. 3 illustrates another example configuration 300 of branched anatomical classification system 100. As shown in configuration 300, system 100 includes graph generator 302, graph analysis algorithm 304, and classification algorithm 306.

System 100 may access segmentation data 202, including branched structure 204. Graph generator 302 may generate a graph based on segmentation data 202. Graph generator 302 may apply any suitable algorithm to generate the graph based on segmentation data 202. For example, graph generator 302 may generate a centerline graph that depicts each branch of branched structure 204 with a line down a center of the branch. The centerline graph may represent each branch as an edge of the graph, with each branching point (where two or more edges meet) represented by a node of the graph. Thus, classifying the branches may then be determined by assigning a label to each edge of the graph. Alternatively, graph generator 302 may generate any other suitable graph based on segmentation data 202. The generated graph may be represented using any suitable data structure or data structures.

System 100 may apply graph analysis algorithm 304 to the graph to determine labels to assign to each edge of the graph. Graph analysis algorithm 304 may include any suitable algorithm (e.g., including machine learning algorithms) configured to analyze graphs. For instance, the algorithm may include determining that any edge that descends from an edge with a known label receives a corresponding label. Thus, branches that branch off a known type of branch (e.g., an artery, a vein, a particular bronchial tube, etc.) may be labeled likewise. For example, branches (i.e., edges) that are downstream of an artery may be labeled arteries, while branches downstream of a vein may be labeled veins. Bronchial tubes downstream of a particular bronchial tube may be labeled to be part of a same bronchial path. Further, graph analysis algorithm 304 may include additional rules and/or algorithms for nodes that are not a straightforward branching of two edges from a single edge. Such algorithms may include determining link affinities between edges of the graph using any suitable algorithm, such as a graph attention network. Examples of graph analysis algorithm 304 are further described herein.

System 100 may apply a classification algorithm 306 to an output of graph analysis algorithm 304 to determine classified branches 208. Classification algorithm 306 may include any suitable algorithm (e.g., including machine learning algorithms) to determine classifications of branches based on the output of graph analysis algorithm 304. For example, graph analysis algorithm 304 may output link affinity values for edges (e.g., at each node) of the graph and classification algorithm 306 may determine labels of edges based on the link affinity values. For instance, classification algorithm 306 may determine possible paths to an edge and determine a probability for each path based on the link affinity values of the edges along the path. Based on the probabilities for each path, classification algorithm 306 may determine a label for the edge and consequently a classification for the branch. Examples of classification algorithm 306 are described herein.

Based on an output of classification algorithm 306, system 100 may provide output data 206 including classified branches 208. Output data 206 may include any suitable representation of classified branches 208, examples of which are described herein. Further, output data 206 may include or be presented in an interface that allows a user to interact with output data 206. For instance, the interface may allow the user to provide input associated with classified branches 208 (e.g., confirming or rejecting a classification of a branch, providing a classification of a branch, etc.). Additionally or alternatively, the interface may allow the user to interact with output data 206 to receive additional information, provide additional information, etc. Examples of user interfaces and interactions of output data 206 are described herein.

While configuration 300 shows system 100 including graph analysis algorithm 304 and classification algorithm 306, in some examples, system 100 may include fewer algorithms (e.g., graph analysis algorithm 304 and classification algorithm 306 may be combined), additional algorithms, and/or different algorithms.

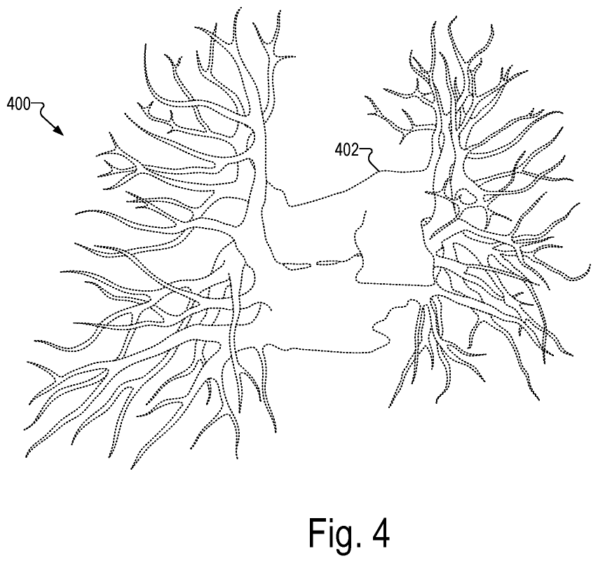

FIG. 4 illustrates an example configuration 400 of a segmentation instance 402. Segmentation instance 402 shows a representation of an implementation of branched structure 204. In this example, branched structure 204 includes a blood vessel structure found in the lungs of a subject. As shown, segmentation instance 402 depicts branched structure 204 apart from surrounding tissue and/or background. However, segmentation instance 402 does not distinguish arteries from veins in branched structure 204.

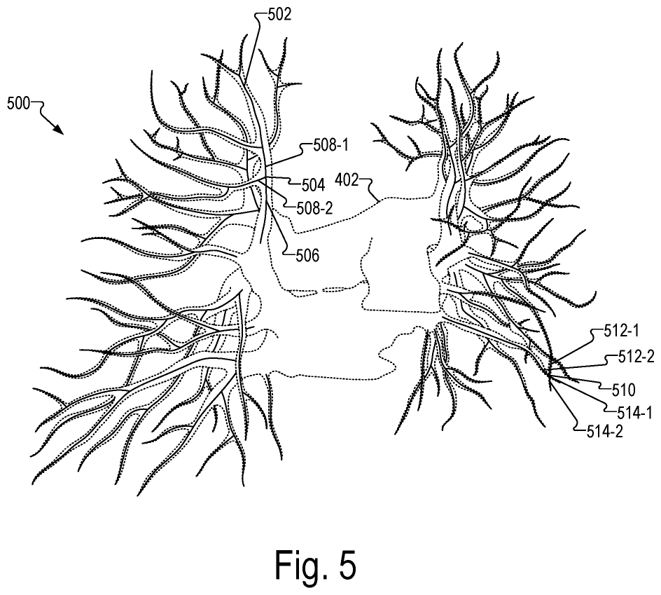

FIG. 5 illustrates an example configuration 500 of segmentation instance 402 that includes a graph 502 generated based on segmentation instance 402. As shown, graph 502 may be generated by determining a centerline for each branch (e.g., blood vessel). In some examples, graph 502 may include a plurality of disconnected centerline graphs, such as shown in configuration 500. Graph 502 may represent each branch of each vessel as an edge of graph 502 and each intersection of two or more edges as a node. A node may thus depict a branching of a vessel into two or more vessels. Alternatively, a node may depict a point in segmentation instance 402 where two vessels overlap and/or run close to one another. In such cases, segmentation instance 402 may mistakenly depict an intersection of vessels that do not anatomically intersect. However, a correct classification of the vessels based on the mistaken intersection node may be difficult to determine.

For instance, a node 504 shows an accurate representation of an intersection of edges, such as edge 506 and edges 508 (e.g., edge 508-1 and 508-2). In this instance, a vessel represented by edge 506 is branching into two vessels, represented by edges 508. As the vessels represented by edges 508 are downstream of the vessel represented by edge 506, system 100 may determine that edges 508 are classified with a same classification as edge 506. Here, as the vessel represented by edge 506 is downstream of a heart vein, the vessels represented by edges 506 and edges 508 may be all classified as veins. In this manner, downstream branches may be classified based on a classification of upstream branches. The initial classification of the heart vein (or an initial classification of any one or more branches) may be determined in any suitable manner. For instance, a user may assign an initial classification of one or more branches. Additionally or alternatively, system 100 may access one or more initial classifications from another system, any suitable algorithm, etc.

However, a node 510 may alternatively depict an intersection of edges 512 (e.g., edge 512-1 and 512-2) and edges 514 (e.g., edges 514-1 and 514-2) that may be an inaccurate representation of an intersection of corresponding vessels. Rather, anatomically, the vessels may run close to one another and then diverge (e.g., the vessel represented by edge 514-1 may be downstream of the vessel represented by edge 512-1 and the vessel represented by edge 514-2 may be downstream of the vessel represented by edge 512-2). Alternatively, the vessels may overlap and cross over one another (e.g., the vessel represented by edge 514-2 may be downstream of the vessel represented by edge 512-1 and the vessel represented by edge 514-1 may be downstream of the vessel represented by edge 512-2). In either case, the vessels may not anatomically intersect. But as segmentation instance 402 may represent node 510 as an intersection, the information for a straightforward determination of which vessel is downstream of which may be lost. Instead, the graph analysis algorithm that system 100 applies to graph 502 may include any suitable algorithms to determine classifications in such instances.

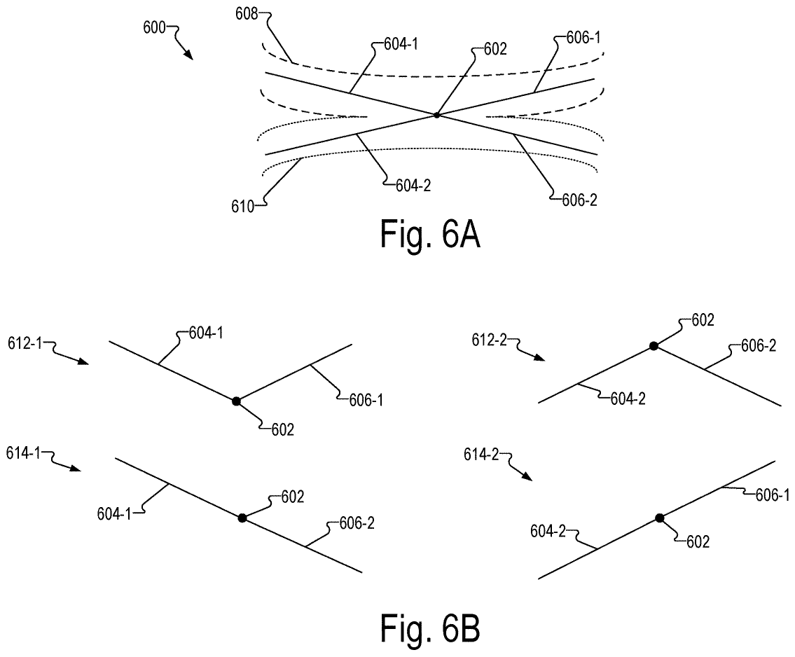

For example, FIG. 6A shows an example configuration 600 that illustrates a portion of a graph such as graph 502. Configuration 600 shows a node 602 that is an intersection of incoming edges 604 (e.g., edge 604-1 and edge 604-2) and outgoing edges 606 (e.g., edge 606-1 and edge 606-2). In this example, edge 604-1 and edge 606-1 may be centerlines of two branches of a first vessel 608, while edge 604-2 and edge 606-2 may be centerlines of two branches of a second vessel 610. As shown, vessel 608 and vessel 610 may be different classifications of vessels (e.g., an artery and a vein, different vessel paths, etc.), as represented by differently dashed lines.

FIG. 6B shows example configurations 612 and 614 of edges 604 and 606 that show possible corresponding vessel configurations based on edges 604, edges 606, and node 602. Configuration 612, which includes configurations 612-1 and 612-2, shows edges 604 and 606 representing two vessels that approach one another and then diverge. Configuration 614, which includes configurations 614-1 and 614-2, shows edges 604 and 606 representing two vessels that cross over one another. In this example, configuration 612 is correct and accurately represents vessels 608 and 610 as they exist anatomically. However, given node 602 includes an intersection of all four edges 604-1, 604-2, 606-1, and 606-2, such a determination may be nontrivial.

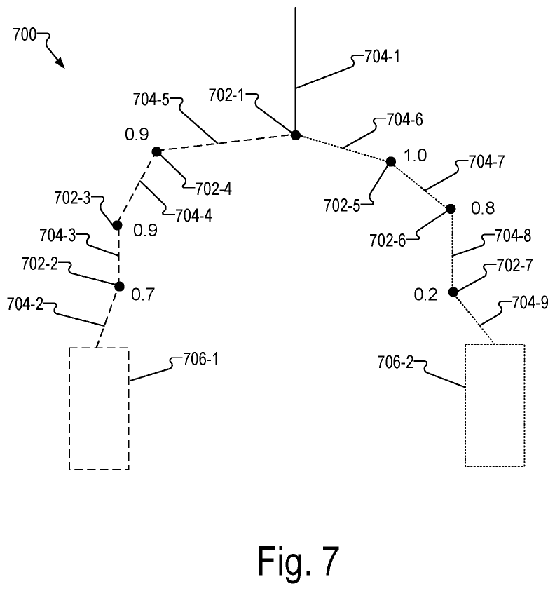

FIG. 7 illustrates an example configuration 700 showing an example graph analysis algorithm and classification algorithm that system 100 may apply to a graph (e.g., graph 502) for determining classifications for such nontrivial cases. Configuration 700 includes nodes 702 (e.g., nodes 702-1 through 702-7) and edges 704 (e.g., edges 704-1 through 704-9). A particular node 702-1 shown in configuration 700 may be an inaccurate representation of an intersection of vessels. A particular edge 704-1 may be downstream of node 702-1, and its classification may therefore be nontrivial.

System 100 may apply a graph analysis algorithm to the graph. For example, the graph analysis algorithm may determine link affinities for edges 704. The link affinities may represent a probability that a particular link between two or more edges (e.g., at a node) is a true connection. The link affinities may be determined in any suitable manner. For example, the graph analysis algorithm may include a graph attention network, which may include a graph neural network trained to predict the link affinities. Additionally or alternatively, the graph analysis algorithm may include determining a weighted combination of any suitable features associated with a node connecting the two or more edges for which the link affinity is being determined. For instance, node features may include characteristics such as a location of the node (e.g., a 3D-coordinate space identifier, a relative location, etc.), a radius of a vessel at the node, a change in radius of a vessel around the node, a distance of the node from known classified vessels, a portion of a segmentation instance around the node, additional imaging of the node, etc. Additionally or alternatively, any other suitable graph analysis algorithm may be applied.

Configuration 700 shows example link affinities at each of nodes 702-2 through 702-7. For instance, node 702-2 shows a link affinity of 0.7, indicating a 70% likelihood that edges 704-2 and 704-3 are truly linked (e.g., edges 704-2 and 704-3 represent branches of a same vessel and/or vessels that are anatomically connected). Similarly, node 702-3 shows a link affinity of 0.9, indicating a 90% likelihood that edges 704-3 and 704-4 are truly connected.

Based on the link affinities output by the graph analysis algorithm, system 100 may apply a classification algorithm to determine a classification of edge 704-1. For example, the classification algorithm may include determining possible paths to edge 704-1. As node 702-1 indicates an intersection of edges 704-5, 704-6, and 704-1, in this example, one possible path to edge 704-1 includes the path shown on the left, including edge 704-2, edge 704-3, edge 704-4, and edge 704-5. This path may be downstream of a vessel 706-1 that may have a first initial classification, such as an artery. Another possible path to edge 704-1 includes the path shown on the right, including edge 704-9, edge 704-8, edge 704-7, and edge 704-6. This other path may be downstream of another vessel 706-2, which may have a second initial classification, such as a vein.

The classification algorithm may generate a link affinity value for each possible path to edge 704-1. The link affinity value for a path may be based on link affinity values of branches included in the path. For instance, the classification algorithm may determine any suitable combination of the link affinity values of the branches of the path, such as a multiplying of the link affinities, a minimum of the link affinities, a weighted combination (e.g., weighting more heavily branches closer to edge 704-1, weighting more heavily branches closer to a vessel with a known classification, etc.), or any other such combination. In configuration 700, the classification algorithm may determine a path link affinity value based on multiplying the branch link affinity values. Thus the link affinity for the path from vessel 706-1 may be 0.567 (0.7×0.9×0.9). The link affinity for the path from vessel 706-2 may be 0.16 (0.2×0.8×1.0). The classification algorithm may consider the link affinity values for each path as a probability of the path consisting of true connections.

The classification algorithm may determine a classification based on the probabilities generated for each path. For example, the classification algorithm may classify edge 704-1 based on a largest path probability. Additionally or alternatively, the classification algorithm may include a threshold probability for classifying edge 704-1. For example, the classification algorithm may include labeling edge 704-1 based on a largest path probability that is above a threshold probability (e.g., 0.5). In this example, as the left path has a larger probability than the right path and is also above 0.5, the classification algorithm may determine that edge 704-1 is connected to the left path, downstream of vessel 706-1. Thus, the classification algorithm may assign a classification of artery to the branch of the vessel represented by edge 704-1. Conversely, the classification algorithm may determine a particular edge to be a vein if a probability of a branch path downstream of a vein is above the threshold probability and also greater than the probability of a branch path downstream of an artery. In this manner, system 100 may determine a classification for each edge of graph 502 that represents each branch of an anatomical branching structure (e.g., branching structure 204) represented by segmentation data (e.g., segmentation data 202).

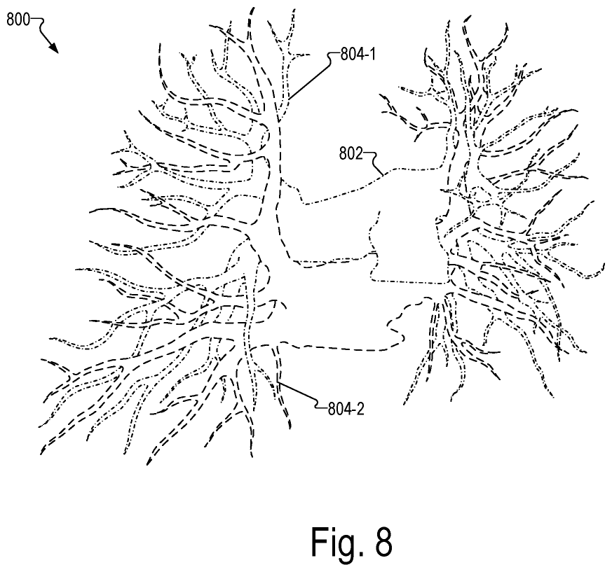

FIG. 8 illustrates an example configuration that shows an output 800 provided by system 100. Output 800 shows a segmentation instance 802 that may be similar to segmentation instance 402, but with information indicating classifications of branches based on the algorithms described herein. For example, output 800 may represent a first classification of vessels (e.g., arteries) 804-1 with a first display representation and a second classification of vessels (e.g., veins) 804-2 with a second display representation. The display representations may include any suitable display characteristics that differentiate vessels 804-1 from vessels 804-2, such as a different dotting and/or dashing of lines, different colors, different textures, different opacities, etc.

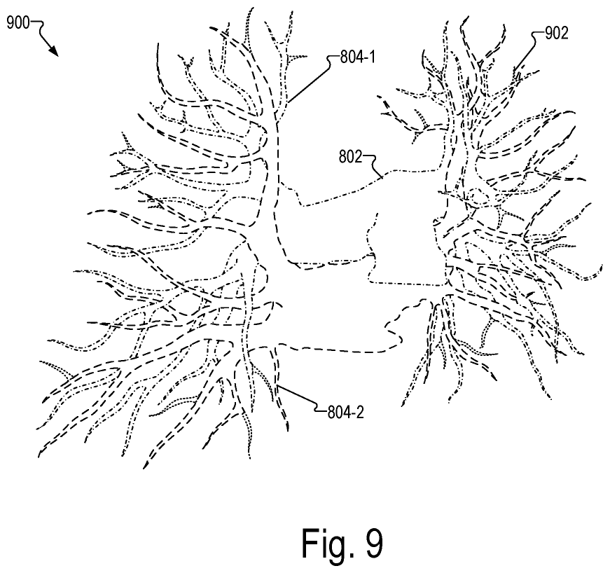

FIG. 9 illustrates an example configuration that shows another example output 900 provided by system 100. Output 900 shows an output similar to output 800 but with additional example interfaces. For instance, output 900 shows segmentation instance 802 with vessels 804-1 and vessels 804-2 shown differentiated based on the classifications determined for each branch by system 100.

However, output 900 further shows some branches 902 that may have a third display representation, different from the display representations for vessels 804. For example, output 900 may show arteries as red and veins as blue, and branches 902 as yellow or some other color. Branches 902 may indicate branches for which the applied algorithms determined a classification probability below a threshold probability. Thus system 100 may indicate a lack of certainty in a determination of the classification for branches 902. Such an indication may be useful, for example, for a user who may be checking the classifications provided by system 100 and/or who is using system 100 to facilitate the classifying of the branches. Output 900 may include an additional interface that allows the user to provide a classification for uncertain branches 902. For example, output 900 may allow the user to click on a branch of branches 902, which may then provide a user interface component for the user to input the classification. Additionally or alternatively, the clicking on the branch may change the classification to a first classification, which may then be changed to a second classification by a second click (e.g., an additional click, a different type of click, a click of a different button, etc.). Additionally or alternatively, output 900 may include any other suitable user interface component that allows the user to classify uncertain branches 902.

Additionally or alternatively, output 900 may include a user interface component that allows the user to reject and/or change a classification of any of branches of vessels 804 provided by system 100. Additionally or alternatively, output 900 may include a user interface component that allows the user to confirm a classification of any of the branches. Additionally or alternatively, output 900 may include a user interface component that allows the user to input any suitable information associated with any of the branches, such as to make a notation, mark a branch, etc.

Additionally or alternatively, system 100 may utilize user input of a classification of any of branches of vessels 804 for classifications of other branches of vessels 804. For instance, as in output 900, system 100 may present to the user branches below a threshold probability. In particular, system 100 may present to the user a node at which the uncertain branches seemingly intersect. Additionally or alternatively, system 100 may present to the user any nodes where the branches seemingly intersect. For example, system 100 may determine a shortest path between a first vessel seed (e.g., a pulmonary artery) and a second vessel seed (e.g., a pulmonary vein). Such a path will depict a node where seemingly a branch downstream from the first vessel seed (e.g., an artery) intersects with a branch downstream from the second vessel seed (e.g., a vein). The user may provide input at the node to provide classifications for each of the branches. Based on the input, system 100 may propagate the classification down the branches of each of the vessels. System 100 may then iteratively provide a next shortest path between the pulmonary artery and pulmonary vein, which may present a next seeming intersection node between vessel types. By resolving shortest paths first, input received from the user may allow system 100 to propagate and automatically classify larger portions of remaining vessels 804 (e.g., using algorithms described herein), allowing for optimized classification of vessels 804.

In some examples, system 100 may provide in such a representation a subset of output 900 and/or accentuate portions of output 900 to highlight a problematic node. For instance, system 100 may depict in output 900 (or a portion of output 900) the shortest path between the pulmonary artery and pulmonary vein. In some examples, system 100 may further depict any vessels connected to the shortest path, up to a constant distance away from the path.

In some examples, as the user provides input that classifies vessels, such classified vessels may be included as part of a seed or an augmented seed (e.g., for determining classifications of downstream vessels, determining a subsequent round of shortest paths of connection between different seeds, etc.), such as a pulmonary artery seed or pulmonary vein seed or any other organ/structure vessel type.

Additionally or alternatively, output 900 may include a user interface component that provides additional information associated with any of the branches. For example, the user may interface with output 900 so that output 900 displays a probability of the classification of a branch. For instance, output 900 may show vessels 804 with different gradations of color (or any other suitable display representation) to indicate a probability of the classification. Additionally or alternatively, output 900 may allow the user to hover a cursor or other user interface mechanism over a branch or click on a branch (or any other suitable user interaction) to show a classification probability of the branch. Additionally or alternatively, output 900 may display any other suitable information associated with a branch, such as a branch path and link affinities along the branch path, etc. Further, output 900 may allow the user to provide input associated with the additional information, such as changing a branch path, changing a link affinity along a branch path, inputting information associated with a branch path, etc.

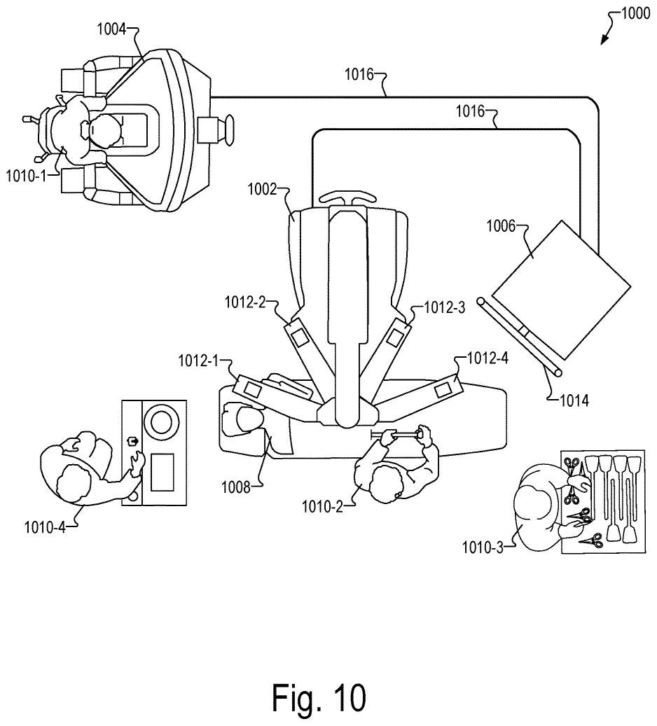

As has been described, system 100 may be associated in certain examples with a computer-assisted medical system used to perform a medical procedure on a subject. To illustrate, FIG. 10 shows an illustrative computer-assisted medical system 1000 that may be used to perform various types of medical procedures including surgical and/or non-surgical procedures.

As shown, computer-assisted medical system 1000 may include a manipulator assembly 1002 (a manipulator cart is shown in FIG. 10), a user control apparatus 1004, and an auxiliary apparatus 1006, all of which are communicatively coupled to each other. Computer-assisted medical system 1000 may be utilized by a medical team to perform a computer-assisted medical procedure or other similar operation on a body of a subject 1008 or on any other body as may serve a particular implementation. As shown, the medical team may include a first user 1010-1 (such as a surgeon for a surgical procedure), a second user 1010-2 (such as a subject-side assistant), a third user 1010-3 (such as another assistant, a nurse, a trainee, etc.), and a fourth user 1010-4 (such as an anesthesiologist for a surgical procedure), all of whom may be collectively referred to as users 1010, and each of whom may control, interact with, or otherwise be a user of computer-assisted medical system 1000. More, fewer, or alternative users may be present during a medical procedure as may serve a particular implementation. For example, team composition for different medical procedures, or for non-medical procedures, may differ and include users with different roles.

While FIG. 10 illustrates an ongoing minimally invasive medical procedure such as a minimally invasive surgical procedure, it will be understood that computer-assisted medical system 1000 may similarly be used to perform open medical procedures or other types of operations. For example, operations such as exploratory imaging operations, mock medical procedures used for training purposes, and/or other operations may also be performed.

As shown in FIG. 10, manipulator assembly 1002 may include one or more manipulator arms 1012 (e.g., manipulator arms 1012-1 through 1012-4) to which one or more instruments may be coupled. The instruments may be used for a computer-assisted medical procedure on subject 1008 (e.g., in a surgical example, by being at least partially inserted into subject 1008 and manipulated within subject 1008). While manipulator assembly 1002 is depicted and described herein as including four manipulator arms 1012, it will be recognized that manipulator assembly 1002 may include a single manipulator arm 1012 or any other number of manipulator arms as may serve a particular implementation. While the example of FIG. 10 illustrates manipulator arms 1012 as being robotic manipulator arms, it will be understood that, in some examples, one or more instruments may be partially or entirely manually controlled, such as by being handheld and controlled manually by a person. For instance, these partially or entirely manually controlled instruments may be used in conjunction with, or as an alternative to, computer-assisted instrumentation that is coupled to manipulator arms 1012 shown in FIG. 10.

During the medical operation, user control apparatus 1004 may be configured to facilitate teleoperational control by user 1010-1 of manipulator arms 1012 and instruments attached to manipulator arms 1012. To this end, user control apparatus 1004 may provide user 1010-1 with imagery of an operational area associated with subject 1008 as captured by an imaging device. To facilitate control of instruments, user control apparatus 1004 may include a set of master controls. These master controls may be manipulated by user 1010-1 to control movement of the manipulator arms 1012 or any instruments coupled to manipulator arms 1012.

Auxiliary apparatus 1006 may include one or more computing devices configured to perform auxiliary functions in support of the medical procedure, such as providing insufflation, electrocautery energy, illumination or other energy for imaging devices, image processing, or coordinating components of computer-assisted medical system 1000. In some examples, auxiliary apparatus 1006 may be configured with a display monitor 1014 configured to display one or more user interfaces, or graphical or textual information in support of the medical procedure. In some instances, display monitor 1014 may be implemented by a touchscreen display and provide user input functionality. Augmented content provided by a region-based augmentation system may be similar, or differ from, content associated with display monitor 1014 or one or more display devices in the operation area (not shown).

Manipulator assembly 1002, user control apparatus 1004, and auxiliary apparatus 1006 may be communicatively coupled one to another in any suitable manner. For example, as shown in FIG. 10, manipulator assembly 1002, user control apparatus 1004, and auxiliary apparatus 1006 may be communicatively coupled by way of control lines 1016, which may represent any wired or wireless communication link as may serve a particular implementation. To this end, manipulator assembly 1002, user control apparatus 1004, and auxiliary apparatus 1006 may each include one or more wired or wireless communication interfaces, such as one or more local area network interfaces, Wi-Fi network interfaces, cellular interfaces, and so forth.

In some examples, one or more components of computer-assisted medical system 1000 may implement system 100 and perform any of the operations described herein. Additionally or alternatively, one or more components of computer-assisted medical system 1000 may be configured to provide any of the output data and/or user interfaces described herein to a user and/or receive input related to the output data from the user. For example, output data generated by system 1000 may be displayed by any display device of computer-assisted medical system 1000 for use in conjunction with a medical procedure. A user of computer-assisted medical system 100 may interact with the output data in any suitable way, including in any of the illustrative ways described herein.

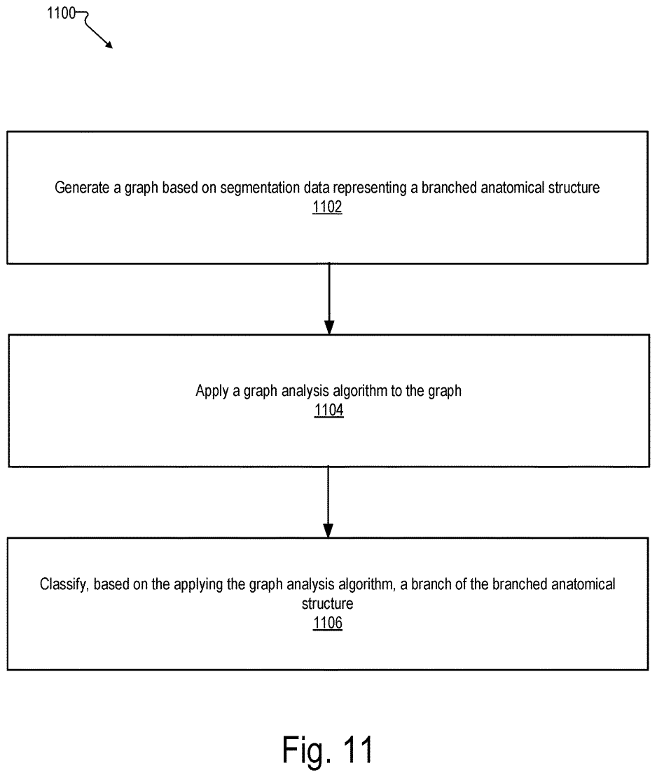

FIG. 11 illustrates an example method 1100 of a branched anatomical classification system. While FIG. 11 illustrates example operations according to one embodiment, other embodiments may omit, add to, reorder, combine, and/or modify any of the operations shown in FIG. 11. One or more of the operations shown in in FIG. 11 may be performed by a branched anatomical classification system such as system 100, any components included therein, and/or any implementation thereof.

At operation 1102, a branched anatomical classification system may generate a graph based on segmentation data representing a branched anatomical structure. In some implementations, the graph may represent a plurality of possible paths to a branch of the branched anatomical structure, the plurality of possible paths comprising a plurality of additional branches. Operation 1102 may be performed in any of the ways described herein.

At operation 1104, the branched anatomical classification system may apply a graph analysis algorithm to the graph. In some implementations, applying the graph analysis algorithm may include generating, for a possible path of the plurality of possible paths to the branch, a path probability value based on link affinity values of pairs of the additional branches on the possible path to the branch. Operation 1104 may be performed in any of the ways described herein.

At operation 1106, the branched anatomical classification system may classify, based on the applying the graph analysis algorithm, a branch of the branched anatomical structure. Operation 1104 may be performed in any of the ways described herein.

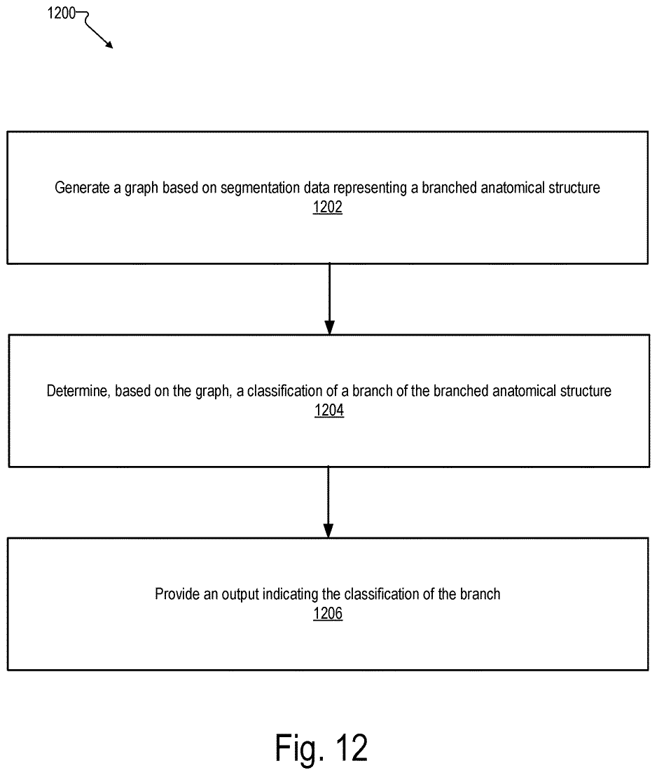

FIG. 12 illustrates another example method 1200 of a branched anatomical classification system. While FIG. 12 illustrates example operations according to one embodiment, other embodiments may omit, add to, reorder, combine, and/or modify any of the operations shown in FIG. 12. One or more of the operations shown in in FIG. 12 may be performed by a branched anatomical classification system such as system 100, any components included therein, and/or any implementation thereof.

At operation 1202, a branched anatomical classification system may generate a graph based on segmentation data representing a branched anatomical structure. Operation 1202 may be performed in any of the ways described herein.

At operation 1204, the branched anatomical classification system may determine, based on the graph, a classification of a branch of the branched anatomical structure. Operation 1204 may be performed in any of the ways described herein.

At operation 1206, the branched anatomical classification system may provide an output indicating the classification of the branch. Operation 1206 may be performed in any of the ways described herein.

In some examples, a non-transitory computer-readable medium storing computer-readable instructions may be provided in accordance with the principles described herein. The instructions, when executed by a processor of a computing device, may direct the processor and/or computing device to perform one or more operations, including one or more of the operations described herein. Such instructions may be stored and/or transmitted using any of a variety of known computer-readable media.

A non-transitory computer-readable medium as referred to herein may include any non-transitory storage medium that participates in providing data (e.g., instructions) that may be read and/or executed by a computing device (e.g., by a processor of a computing device). For example, a non-transitory computer-readable medium may include, but is not limited to, any combination of non-volatile storage media and/or volatile storage media. Illustrative non-volatile storage media include, but are not limited to, read-only memory, flash memory, a solid-state drive, a magnetic storage device (e.g. a hard disk, a floppy disk, magnetic tape, etc.), ferroelectric random-access memory (“RAM”), and an optical disc (e.g., a compact disc, a digital video disc, a Blu-ray disc, etc.). Illustrative volatile storage media include, but are not limited to, RAM (e.g., dynamic RAM).

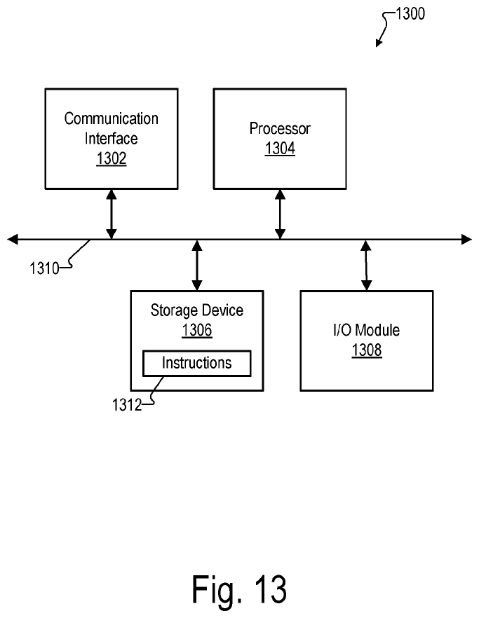

FIG. 13 illustrates an example computing device 1300 that may be specifically configured to perform one or more of the processes described herein. Any of the systems, units, computing devices, and/or other components described herein may implement or be implemented by computing device 1300.

As shown in FIG. 13, computing device 1300 may include a communication interface 1302, a processor 1304, a storage device 1306, and an input/output (“I/O”) module 1308 communicatively connected one to another via a communication infrastructure 1310. While an example computing device 1300 is shown in FIG. 13, the components illustrated in FIG. 13 are not intended to be limiting. Additional or alternative components may be used in other embodiments. Components of computing device 1300 shown in FIG. 13 will now be described in additional detail.

Communication interface 1302 may be configured to communicate with one or more computing devices. Examples of communication interface 1302 include, without limitation, a wired network interface (such as a network interface card), a wireless network interface (such as a wireless network interface card), a modem, an audio/video connection, and any other suitable interface.

Processor 1304 generally represents any type or form of processing unit capable of processing data and/or interpreting, executing, and/or directing execution of one or more of the instructions, processes, and/or operations described herein. Processor 1304 may perform operations by executing computer-executable instructions 1312 (e.g., an application, software, code, and/or other executable data instance) stored in storage device 1306.

Storage device 1306 may include one or more data storage media, devices, or configurations and may employ any type, form, and combination of data storage media and/or device. For example, storage device 1306 may include, but is not limited to, any combination of the non-volatile media and/or volatile media described herein. Electronic data, including data described herein, may be temporarily and/or permanently stored in storage device 1306. For example, data representative of computer-executable instructions 1312 configured to direct processor 1304 to perform any of the operations described herein may be stored within storage device 1306. In some examples, data may be arranged in one or more databases residing within storage device 1306.

I/O module 1308 may include one or more I/O modules configured to receive user input and provide user output. I/O module 1308 may include any hardware, firmware, software, or combination thereof supportive of input and output capabilities. For example, I/O module 1308 may include hardware and/or software for capturing user input, including, but not limited to, a keyboard or keypad, a touchscreen component (e.g., touchscreen display), a receiver (e.g., an RF or infrared receiver), motion sensors, and/or one or more input buttons.

I/O module 1308 may include one or more devices for presenting output to a user, including, but not limited to, a graphics engine, a display (e.g., a display screen), one or more output drivers (e.g., display drivers), one or more audio speakers, and one or more audio drivers. In certain embodiments, I/O module 1308 is configured to provide graphical data to a display for presentation to a user. The graphical data may be representative of one or more graphical user interfaces and/or any other graphical content as may serve a particular implementation.

In some examples, any of the systems, modules, and/or facilities described herein may be implemented by or within one or more components of computing device 1300. For example, one or more applications residing within storage device 1306 may be configured to direct an implementation of processor 1304 to perform one or more operations or functions associated with processing facility 104 of system 100.

As mentioned, one or more operations described herein may be performed during a medical procedure, e.g., dynamically, in real time, and/or in near real time. As used herein, operations that are described as occurring “in real time” will be understood to be performed immediately and without undue delay, even if it is not possible for there to be absolutely zero delay.

Any of the systems, devices, and/or components thereof may be implemented in any suitable combination or sub-combination. For example, any of the systems, devices, and/or components thereof may be implemented as an apparatus configured to perform one or more of the operations described herein.

In the description herein, various example embodiments have been described. It will, however, be evident that various modifications and changes may be made thereto, and additional embodiments may be implemented, without departing from the scope of the invention as set forth in the claims that follow. For example, certain features of one embodiment described herein may be combined with or substituted for features of another embodiment described herein. The description and drawings are accordingly to be regarded in an illustrative rather than a restrictive sense.

1. A method comprising:
generating, by a computing device, a graph based on segmentation data representing a branched anatomical structure, the graph representing a plurality of possible paths to a branch of the branched anatomical structure, the plurality of possible paths comprising a plurality of additional branches;
applying, by the computing device, a graph analysis algorithm to the graph, wherein the applying the graph analysis algorithm comprises generating, for a possible path of the plurality of possible paths to the branch, a path probability value based on link affinity values of pairs of the additional branches on the possible path to the branch; and
classifying, by the computing device and based on the applying the graph analysis algorithm, a branch of the branched anatomical structure.

2. The method of claim 1, wherein the graph analysis algorithm further comprises a graph attention network.

3. The method of claim 1, wherein the generating the path probability value for the possible path comprises multiplying the link affinity values of the pairs of the additional branches on the possible path.

4. The method of claim 1, wherein the generating the path probability value for the possible path comprises determining a minimum link affinity value of the pairs of the additional branches on the possible path.

5. The method of claim 1, wherein the classifying the branch comprises generating a probability of a classification of the branch.

6. The method of claim 1, further comprising generating, based on the classifying, an output indicating a classification of the branch.

7. (canceled)

8. The method of claim 6, wherein the output comprises an indication of a probability associated with the classification.

9. (canceled)

10. The method of claim 8, wherein the output further comprises an indication of probabilities associated with additional branches of a branch path including the branch.

11. The method of claim 6, wherein the output comprises an interface for receiving input from a user.

12. The method of claim 11, wherein the input comprises a changing of the classification.

13. The method of claim 11, wherein the input comprises a rejecting of the classification.

14. (canceled)

15. (canceled)

16. The method of claim 1, wherein:
the branched anatomical structure comprises a blood vessel structure;
the classifying the branch comprises determining a classification of the branch as an artery or a vein; and
the method further comprises generating an output indicating the classification of the branch.

17. The method of claim 1, wherein:
the branched anatomical structure comprises a blood vessel structure;
the classifying the branch comprises determining that a classification of the branch as uncertain based on determining a probability of the branch being an artery is below a first threshold probability and determining a probability of the branch being a vein is below a second threshold probability; and
the method further comprises generating an output indicating the uncertain classification of the branch.

18. The method of claim 17, wherein:
the generating the output further comprises providing an interface configured to receive an input from a user comprising a classification of the branch;
the method further comprises determining a shortest path from an artery seed and a vein seed; and
the interface is further configured to present an intersection on the shortest path, the intersection leading to the branch and seemingly downstream from both the artery seed and the vein seed.

19. (canceled)

20. The method of claim 1, wherein:
the branched anatomical structure comprises a blood vessel structure;
the classifying the branch comprises determining a classification of the branch as an artery based on determining a probability of the branch being an artery meets a first threshold probability and determining the probability of the branch being the artery is greater than a probability of the branch being a vein; and
the method further comprises generating an output that comprises an indication of the classification of the branch as the artery and an indication of the probability of the branch being the artery.

21. (canceled)

22. The method of claim 20, wherein the indication of the probability of the branch being the artery comprises a coloring of the branch.

23. The method of claim 1, wherein:
the branched anatomical structure comprises a bronchial airway structure; and
the classifying the branch comprises determining a classification of the branch as connected to a particular bronchial path.

24. The method of claim 1, wherein:
the branched anatomical structure comprises a nerve structure; and
the classifying the branch comprises determining a classification of the branch as connected to a particular nerve path.

25. A system comprising:
a memory storing instructions; and
a processor communicatively coupled to the memory and configured to execute the instructions to perform a process comprising:
generating, by a computing device, a graph based on segmentation data representing a branched anatomical structure, the graph representing a plurality of possible paths to a branch of the branched anatomical structure, the plurality of possible paths comprising a plurality of additional branches;
applying, by the computing device, a graph analysis algorithm to the graph, wherein the applying the graph analysis algorithm comprises generating, for a possible path of the plurality of possible paths to the branch, a path probability value based on link affinity values of pairs of the additional branches on the possible path to the branch; and
classifying, by the computing device and based on the applying the graph analysis algorithm, a branch of the branched anatomical structure.

26. A non-transitory computer-readable medium storing instructions executable by a processor to perform a process comprising:
generating, by a computing device, a graph based on segmentation data representing a branched anatomical structure, the graph representing a plurality of possible paths to a branch of the branched anatomical structure, the plurality of possible paths comprising a plurality of additional branches;
applying, by the computing device, a graph analysis algorithm to the graph, wherein the applying the graph analysis algorithm comprises generating, for a possible path of the plurality of possible paths to the branch, a path probability value based on link affinity values of pairs of the additional branches on the possible path to the branch; and
classifying, by the computing device and based on the applying the graph analysis algorithm, a branch of the branched anatomical structure.
